(19) United States
(12) Patent Application Publication
(10) Pub. No.: US 2018/0122024 A1
(43) Pub. Date: May 3, 2018

(54) Systems and Methods for Use in Providing Offers to Consumers Based on Transit Conditions

(71) Applicant: MASTERCARD INTERNATIONAL INCORPORATED, Purchase, NY (US)

(72) Inventors: Travis Michael Carpenter, Glencoe, MO (US); Kyle P. Clark, High Ridge, MO (US)

(21) Appl. No.: 15/340,798

(22) Filed: Nov. 1, 2016

(51) Int. Cl. G06Q 50/14; G06Q 30/02

(52) U.S. Cl. CPC G06Q 50/14; G06Q 30/0261; G06Q 30/0269; G06Q 30/0235

(57) ABSTRACT

Systems and methods are provided for use in identifying offers for consumers based on transit conditions. One exemplary method includes in response to a transit condition, accessing, by a computing device, a consumer profile for a consumer associated with the transit condition and an offer data structure having multiple offers relating to discounted purchase transactions, where each of the multiple offers are associated with a merchant. The method also includes selecting, by the computing device, at least one of the multiple offers, from the offer data structure, based on the transit condition and the consumer profile, and then issuing, by the computing device, the selected at least one offer to the consumer, at a communication device associated with the consumer, thereby permitting the consumer to redeem the selected at least one offer at the merchant associated with the at least one offer.

### FIELD

The present disclosure generally relates to systems and methods for providing offers to consumers based on transit conditions and, in particular, to systems and methods for selecting such offers for the consumers based on transit conditions encountered by the consumers during travel, and then providing the selected offers to the consumers.

### BACKGROUND

This section provides background information related to the present disclosure which is not necessarily prior art.

Consumers use payment accounts to purchase various different products and services including, for example, tickets or passes for travel via trains, airplanes, buses, etc. At the time of the travel, the consumers are present at origination locations of the travel and, in order to begin their travel, present their tickets or passes for redemption. Often, in connection with the redemption, the consumers are required to present identification, whereby the consumers may be authenticated to the tickets or passes. The tickets or passes may be one-time use tickets (e.g., airline tickets, etc.), in which case they are redeemed once, or the tickets or passes may be multiple-use pass (e.g., monthly train or bus passes, etc.), in which case they are redeemed multiple times. The travel is further known to be provided at or associated with particular schedules, defining departure and/or arrival locations/times for the travel. From time to time, however, the travel may be delayed relative to such schedules for one or more reasons and without notice, whereby the consumers arrive at destination locations generally later than scheduled. In many cases, this delay can cause inconveniences or other problems for the consumers (e.g., lost time, missed appointments, etc.).

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in selecting offers for consumers based on transit conditions encountered by and/or associated with the consumers;

FIG. 2 is a block diagram of a computing device that may be used in the exemplary system of FIG. 1; and

FIG. 3 is an exemplary method that may be implemented in connection with the system of FIG. 1 for selecting an offer for a consumer based on a transit condition encountered by the consumer during travel.

Corresponding reference numerals indicate corresponding parts throughout the several views of the drawings.

### DETAILED DESCRIPTION

The description and specific examples included herein are intended for purposes of illustration only and are not intended to limit the scope of the present disclosure.

Travel events (e.g., flights, train rides, ferry rides, etc.) are typically subject to a number of transit conditions, such as, for example, delays, overcrowding, cancellations, etc. These transit conditions may not only negatively impact consumers' perceptions of the transit merchants and/or transit authorities involved in providing the transit events, but may also affect later transit events thereby affecting other consumers. Uniquely, the systems and methods herein provide various product offers to consumers in response to such transit conditions, to help alleviate any inconveniences and/or other problems experienced by the consumers as a result of the transit conditions. In particular, upon identifying a transit condition, an offer engine identifies one or more consumers affected by the transit condition (e.g., a passenger on a delayed flight, etc.) and accesses multiple offers for the consumers based on the transit condition. The offers may relate to merchants in the current vicinity of the consumers or in the vicinity of the transit event(s) subject to the transit condition, or the offers may relate to alternate transit events (as alternates to the transit events affected by the transit condition). The offer engine then selects particular ones of the offers for the consumers (e.g., based on profiles for the consumers, etc.) and issues the offers to the consumers. The consumers are then able to redeem the offers by enrolling, for example, in the offers and abiding by the terms of the offers. In this manner, the offers may be provided to the consumers to offset the impact of the transit conditions, and soften any negative perception of the transit merchants and/or transit authorities associated with the affected transit events. What's more, the offers may also enable the transit merchants and/or the transit authorities to alter, for example, loading of the transit events when affected by the transit conditions. Specifically, the transit merchants and/or the transit authorities may contribute to (e.g., supplement, etc.) existing offers, or originate new offers, to even further incentivize the consumers beyond what the merchants (including transit merchants) would normally offer to the consumers, thereby facilitating additional acceptance of the transit conditions and, potentially, diverge the consumers therefrom (and/or from particularly adversely affected transit events).

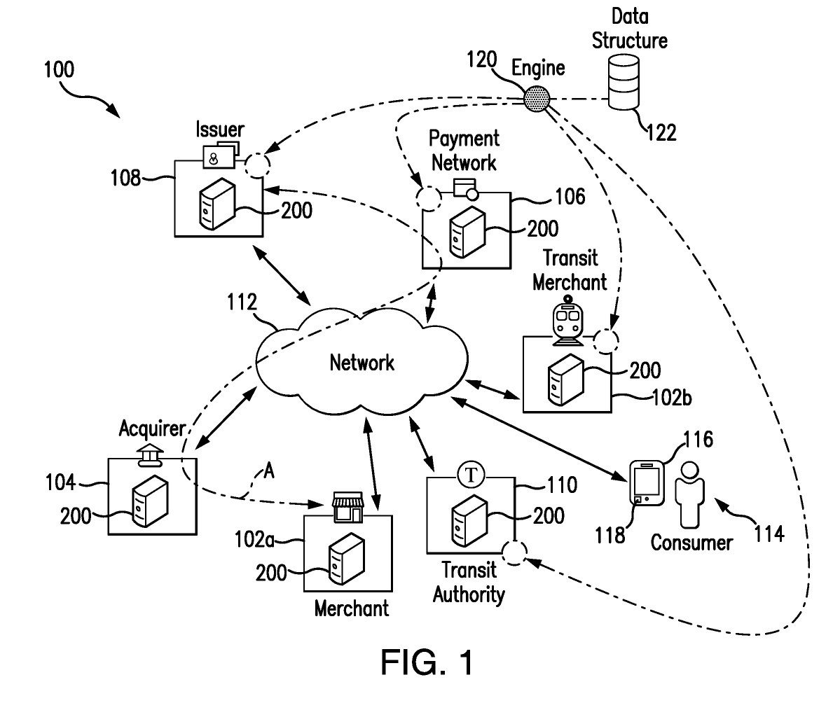

FIG. 1 illustrates an exemplary system 100, in which the one or more aspects of the present disclosure may be implemented. Although the system 100 is presented in one arrangement, other embodiments may include systems arranged otherwise depending, for example, on particular types of transit included in the systems to accommodate travel, accessibility of transit data within the systems, accessibility of consumer data within the systems, processing of purchase options for travel and other products within the systems, etc.

As shown in FIG. 1, the illustrated system 100 generally includes merchants 102a-b, an acquirer 104 associated with the merchants 102a-b, a payment network 106, an issuer 108 configured to issue payment accounts to consumers, and a transit authority 110, each coupled to (and in communication with) network 112. The network 112 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, the network 112 may include multiple different networks, such as a private payment transaction network made accessible by the payment network 106 to the acquirer 104 and the issuer 108 and, separately, the public Internet, which is accessible as desired to the merchants 102a-b, the acquirer 104, the payment network 106, the issuer 108, and/or the transit authority 110, etc.

In the illustrated system 100, the merchants 102a-b generally represent different types of merchants. In particular, the merchant 102a includes a merchant offering various consumable products (e.g., goods and/or services, etc.) for sale to consumers, including consumer 114 (generally other than travel products). For example, the merchant 102a may include, without limitation, a restaurant, a movie theatre, a clothing store, etc. Often, the merchant 102a is located in the vicinity of a transit event offered to (and/or taken by) the consumer 114. In one example, the merchant 102a includes a store located in an airport, while in another example the merchant 102a includes a restaurant located across the street from a train station. Notwithstanding these specific examples, the merchant 102a may alternatively be located apart from the vicinity of the transit event in a variety of different embodiments, and/or may include a merchant with a virtual location (e.g., a website, etc.) accessible by the consumer 114 while in the vicinity of the transit event (or otherwise).

The merchant 102b, then, is a transit merchant, which offers for sale tickets and/or passes for transit events, such as, for example, flights, train rides, bus trips, ferry rides, etc., within one or more region and/or between multiple different regions (broadly, transit products herein). The transit merchant 102b may be configured to offer tickets and/or passes for different types of transit events (e.g., as a travel agent capable of providing tickets and/or passes for both flights and train rides, etc.), or may be limited to offering tickets and/or passes for particular types of transit events (e.g., flights only, etc.).

In connection therewith, the transit authority 110 is involved in facilitating the transit events associated with the tickets and/or passes offered by the transit merchant 102b. As part of these responsibilities, the transit authority 110 often imposes rules on the sale and/or redemption of tickets and/or passes for transit events. In addition, one or both of the transit merchant 102b and the transit authority 110 monitor the usage of the transit events, the schedules of the transit events, etc. And, in so doing, one or both of the transit merchant 102b and the transit authority 110 also identify transit conditions, such as, for example, delayed transit events, cancelled transit events, overbooked and/or overcrowded transit events (e.g., where attendance of a transit event exceeds a predetermined threshold, etc.), over utilized transit facilities (e.g., airports, bus stations, train stations, etc.), etc. In response, the transit merchant 102b and/or the transit authority 110 may attempt to inform consumers of the transit events and their status, and when such transit conditions occur, through appropriate notifications (e.g., through short-message service (SMS) notifications, through email notifications, through postings to status monitors viewable in the transit facilities, etc.). In one or more embodiments, the transit merchant 102b and the transit authority 110 may be at least partially integrated, if not the same entity.

With continued reference to FIG. 1, the consumer 114 in the system 100 is associated with a payment account provided to the consumer 114 by the issuer 108. And, through the payment account, the consumer 114 is able to fund purchase transactions at the merchant 102a and/or the transit merchant 102b for desired products. In addition, the consumer 114 is also associated with a communication device 116, which may include, for example, a portable communication device such as a smartphone, a tablet, a laptop, etc. The communication device 116 includes an application 118, which configures the communication device 116, through executable instructions, to operate as described herein. The application 118 may include, or may form part of, a payment application associated with the consumer's payment account (e.g., a virtual wallet application, etc.), or it may include a stand-alone application not part of a payment application. With that said, when the communication device 116 is described as configured to perform various operations herein, it should be appreciated that it may be doing so generally in coordination with the application 118 (even if the application 118 is not specifically referenced), or not.

Generally in the system 100, when the consumer 114 wishes to make a purchase at the merchant 102a, for example, the consumer 114 presents to the merchant 102a a payment device associated with the consumer's payment account. The payment device may include, without limitation, a credit card, a debit card, a prepaid card, a fob, or if applicable, the communication device 116, when the communication device 116 includes a payment application.

In turn, the merchant 102a captures payment account information from the payment device. Then, the merchant 102a compiles and communicates an authorization request for the purchase transaction to the acquirer 104, along path A in FIG. 1, identifying, for example, a payment account number for the payment device and an amount of the purchase. The acquirer 104, in turn, communicates the authorization request to the issuer 108, through the payment network 106 (e.g., through MasterCard®, VISA®, Discover®, American Express®, etc.) (along path A), to determine (in conjunction with the issuer 108 that provided the payment account to the consumer 114) whether the payment account is in good standing and whether there is sufficient credit or funds to complete the purchase. If the issuer 108 accepts the transaction, a reply authorizing the transaction is provided back to the acquirer 104 and the merchant 102a, thereby permitting the merchant 102a to complete the transaction. The transaction is later cleared and/or settled by and between the merchant 102a and the acquirer 104 (via an agreement between the merchant 102a and the acquirer 104), and by and between the acquirer 104 and the issuer 108 (via an agreement between the acquirer 104 and the issuer 108). If the issuer 108 declines the transaction, however, a reply declining the transaction is provided back to the merchant 102a, thereby permitting the merchant 102a to stop the transaction.

While the above purchase transaction is described with reference to the merchant 102a, it should be appreciated that a transaction between the consumer 114 and the transit merchant 102b would be substantially similar. In addition, while the above purchase transaction is described with reference to a credit account, it should be appreciated that purchase transactions may include other transactions, such as debit transactions and pre-paid transactions. For debit and pre-paid accounts, a purchase transaction, and processing thereof, is again substantially similar to the above transaction, but may further include the use of personal identification numbers (PINs) to authorize the transactions and/or may include more rapid posting of the charges to the corresponding payment accounts.

Transaction data is generated, collected, and stored as part of the various interactions among the merchants 102a-b, the acquirer 104, the payment network 106, the issuer 108, and the consumer 114. The transaction data represents at least a plurality of transactions, e.g., completed transactions, attempted transactions, etc. The transaction data, in this exemplary embodiment, is stored at least by the payment network 106 (e.g., in a data structure associated with the payment network 106, etc.). Additionally, or alternatively, the merchants 102a-b, the acquirer 104 and/or the issuer 108 may store the transaction data, or part thereof, in a data structure, or transaction data may be transmitted between parts of system 100, as used or needed. The transaction data includes, for example, payment account numbers (e.g., primary account numbers (PANs), etc.), amounts of the transactions, merchant IDs, merchant category codes (MCCs), dates/times of the transactions, products purchased and related descriptions or identifiers, etc. It should be appreciated that more or less information related to transactions, as part of either authorization and/or clearing and/or settling, may be included in transaction data and stored within the system 100, at the merchants 102a-b, the acquirer 104, the payment network 106, and/or the issuer 108.

In various exemplary embodiments, the consumers involved in the different transactions herein (including the consumer 114) are prompted to agree to legal terms associated with their payment accounts, for example, during enrollment in their accounts, etc. In so doing, the consumers may voluntarily agree, for example, to allow merchants, issuers, payment networks, etc., to use data collected during enrollment and/or collected in connection with processing the transactions, subsequently for one or more of the different purposes described herein. Enrollment can be carried out in a variety of ways, for example, through a web interface, through an application store, and/or through a credit account issuer or other financial institution. With that said, there may be some transaction data that will not be shared even if the consumers do consent, for example, when it would be against policy or otherwise inappropriate. Further, the consumers may be afforded many options through their accounts, but some may still be restricted for legal or policy reasons or the like (e.g., appropriate age limits are preferably enforced on those enrolling, regardless of options; etc.). Moreover, appropriate usage limits are preferably placed on use of the publication, dissemination, and/or sharing of the transaction data. Of course, all applicable laws, rules, regulations, policies and procedures with respect to age of consumers, privacy, and the like will always be fully followed.

While only one merchant 102a, one transit merchant 102b, and one transit authority 110 are shown in FIG. 1, it should be appreciated that other embodiments may include multiple ones of such entities. In addition, while one acquirer 104, one payment network 106, one issuer 108, and one consumer 114 are illustrated in FIG. 1, it should be appreciated that any number of these entities (and their associated components) may be included in the system 100, or may be included as a part of systems in other embodiments, consistent with the present disclosure.

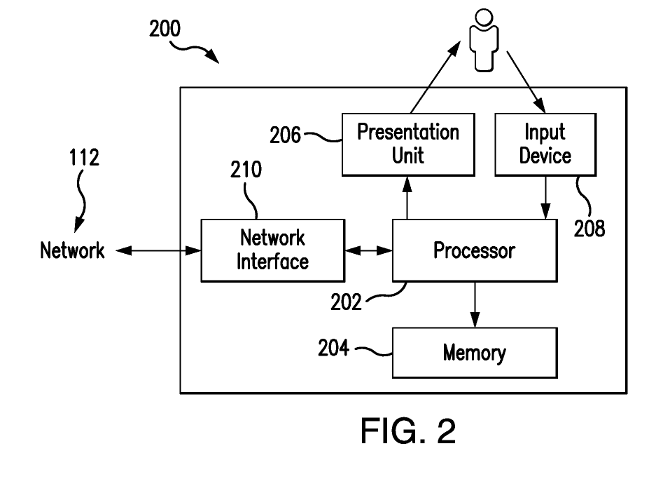

FIG. 2 illustrates an exemplary computing device 200 that can be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are specifically configured to function as described herein.

In the exemplary embodiment of FIG. 1, each of the merchants 102a-b, the acquirer 104, the payment network 106, the issuer 108, and the transit authority 110 are illustrated as including, or being implemented in, computing device 200, coupled to (and in communication with) the network 112. In addition, the communication device 116 associated with consumer 114 can also be considered a computing device consistent with computing device 200 for purposes of the description herein. The system 100, however, should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, transit data (e.g., transit schedules (e.g., times, origins, destinations, etc.), transit routes, transit passes and related details, etc.), product offers (including transit product offers), consumer profiles, payment account information and credentials, transit conditions, location data, current events, weather information, traffic information, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is identifying and/or presenting purchase options to the consumer 114, for example. It should be appreciated that the memory 204 may include a variety of different memories, each implemented in one or more of the functions or processes described herein.

In addition, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information (e.g., transit schedules, transit conditions, offers for products at merchants 102a-b, etc.), either visually or audibly to a user of the computing device 200, for example, the consumer 114 in the system 100, etc. It should be appreciated that various interfaces (e.g., application interfaces, webpages, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

The computing device 200 also includes an input device 208 that receives inputs from the user (i.e., user inputs) such as, for example, selections of offers, requests for offers, entries of transit information, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

Further, the illustrated computing device 200 includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 112. Further, in some exemplary embodiments, the computing device 200 includes the processor 202 and one or more network interfaces incorporated into or with the processor 202. Moreover, in various embodiments herein, the input device 208 and/or the network interface 210 of the computing device 200 may include, among other things, a GPS antenna suitable to capture GPS signals for processing by the processor 202 to determine a location of the computing device 200, etc.

Referring again to FIG. 1, the system 100 further includes an offer engine 120, and a data structure 122 coupled thereto. The offer engine 120 is illustrated as a standalone part of the system 100 and, as such, may be consistent with the computing device 200. Additionally, as indicated by the dotted lines, the offer engine 120 may be incorporated, in whole or in part, into the transit merchant 102b, the payment network 106, the issuer 108, and/or the transit authority 110. The data structure 122 is also illustrated as a separate part of the system 100, and separate from the offer engine 120. However, the data structure 122 may also be incorporated in whole, or in part, in the offer engine 120, as indicated by the dotted line therebetween, or in other parts of the system 100 (e.g., in another computing device 200 in the system, etc.). In various embodiments, if the offer engine 120 is incorporated into the transit merchant 102b, the payment network 106, the issuer 108, and/or the transit authority 110, the data structure 122 will likewise be incorporated therein, again, in whole or in part.

Generally in the system, the offer engine 120 is configured, by computer-executable instructions, to operate as described herein. More particularly, and as will be described in more detail next, the offer engine 120 is configured to interact with the consumer's communication device 116, via the application 118, to identify and provide offers to the consumer 114 based on transit conditions encountered by and/or associated with the consumer 114.

In connection therewith, the data structure 122 generally includes multiple data structures, as indicated by the segregating lines in FIG. 1. In particular, in this example, the data structure 122 includes three separate data structures: a consumer data structure, a transit data structure, and an offer data structure.

The consumer data structure includes various data related to the consumer 114 and his/her travel (e.g., as part of a consumer profile for the consumer 114 generated by the offer engine 120 in registering the consumer 114 for the transit services described herein, generated by the offer engine 120 upon installation of the application 118 at the consumer's communication device 116, etc.). The consumer data structure may be populated in connection with the consumer 114, the transit merchant 102b, the payment network 106 and/or the issuer 108. In this exemplary embodiment, the communication device 116, as configured by the application 118, tracks the travel behavior of the consumer 114 for use, at least in part, to populate the consumer data structure. Specifically, for example, the communication device 116 may generate location records every 5 minutes, 10 minutes, 30 minutes, or hour, or at other suitable intervals, in the exemplary format: [time, location]. The travel records are then communicated from the communication device 116, via the application 118, for example, to the offer engine 120, via the network 112, as they are recorded, or in one or more intervals (as a bulk file), and stored in the consumer data structure of the data structure 122, as indicative of the travel of the consumer 114.

In addition to such automated location tracking, the communication device 116 may also be configured to receive travel entries from the consumer 114. For example, the consumer 114 may enter or capture travel and/or location data in the exemplary format: [transit type, transit name, start location, start time, stop location, stop time]. In so doing, the data may then also be stored in the consumer data structure of the data structure 122 by the offer engine 120 (in the same manner described above). Such data may also be captured, at least in part, from a calendar application associated with the consumer's communication device 116 (e.g., via the application 118, etc.).

With that said, Table 1 illustrates three exemplary travel entries for the consumer 114, as may be included in the consumer data structure (e.g., in a consumer profile for the consumer 114, etc.). Here, when beginning to travel, the consumer 114 may provide an input to the communication device 116 regarding transit type and transit name. And, in turn, the communication device 116 may be configured (by the application 118) to capture the location and time content shown in Table 1, based on the consumer's input.

TABLE 1

| Transit | Transit | Start | Start | Stop | Stop |
|---|---|---|---|---|---|
| Type | Name | Location | Time | Location | Time |
| Subway | E Train | 40.744813, | 0735 | 40.755736, | 0815 |
| | | −73.800354 | | −73.985748 | |
| Train | Waterbury | 40.755736, | 0835 | 40.980702, | 0921 |
| | | −73.985748 | | −73.683109 | |
| Bus | Route 26 | 40.980573, | 0925 | 41.023616, | 1005 |
| | | −73.683796 | | −73.714352 | |

It should be appreciated that travel may be tracked or otherwise provided to the offer engine 120 in a variety of manners, consistent with the above formats, or otherwise, by the communication device 116 (via the application 118). It should also be appreciated that the tracking of the consumer 114, both automatically and by inputs from the consumer 114, is the product of the consumer 114 opting into the tracking service, by the application 118 at his/her communication device 116, and which, in various embodiments, may be deactivated or otherwise halted by the consumer 114 at any desired time by simply opting out of the tracking service (at the application 118, for example). And, when not tracking the consumer 114 (e.g., when the consumer 114 has opted out of the tracking service, etc.), the application 118 and/or the offer engine 120 is/are configured to attempt to define and/or approximate a location of the consumer 114 based on the consumer's current/recent transit event(s) (e.g., as shown in or indicated by transaction data for the consumer 114, etc.).

Further to the above, the consumer data structure also includes transaction data for the consumer 114 indicative of travel for the consumer 114 (e.g., past travel, upcoming travel, etc.). For example, the consumer data structure may include transaction data for tickets and/or passes purchased by the consumer 114 at the transit merchant 102b and other transit merchants (broadly, transit transaction data). The transit transaction data may include purchase details for a ticket and/or pass and location details for the corresponding travel (much like the above travel records shown in Table 1), or it may include the particular travel details associated with the purchased ticket and/or pass (e.g., for a flight, it may include airline name, flight number, origin city, destination city, flight time/date, etc.; etc.). In various embodiments, the consumer data structure may also include other transaction data for the consumer 114 (other than transit transaction data), for example (and without limitation), transaction data relating to food purchases, entertainment purchases, etc. Such transaction data may be retrieved by the offer engine 120 from the payment network 106 and/or the issuer 108, and stored in the consumer data structure as appropriate.

Moreover, in various embodiments, the consumer data structure may also include demographic information related to the consumer 114, such as, for example, age, gender, geographic region, birthdate, race, income, marital status, employment status, nationality, etc.

The transit data structure of the data structure 122 includes transit events for the transit merchant 102b and for other transit merchants (not shown) in the system 100. Such information associated with the transit events may include, without limitation, times/dates for the transit events, originations, destinations, transit types, transit names, pricing, etc. In connection therewith, the transit data structure may be limited to a certain type of transit event (e.g., train rides, etc.), or it may include various different types of transit events (e.g., train rides, airline flights, bus rides, ferry rides, etc.). In addition, the transit data structure may be updated at one or more regular or irregular intervals with status information related to the travel events, such as, for example, delays, capacities, demands, etc. The updates may be facilitated by the offer engine 120, whereby the offer engine is configured to retrieve the updates from the transit merchant 102b (or the transit authority 110). Or, the updates may be facilitated by the transit merchant 102b (or the transit authority 110), whereby the transit merchant 102b (or the transit authority 110) provide the updates to the offer engine 120 for storing in the transit data structure. While the transit data structure is shown as part of the data structure 122, it should be appreciated that the transit data structure may be stored elsewhere, for example, as a data structure included in the transit authority 110, etc.

The offer data structure of the data structure 122 includes multiple offers available from (and potentially provided by) the merchant 102a, the transit merchant 102b, the transit authority 110, and/or any other merchants and/or entities involved in one or more transit events associated with the system 100. Such offers generally include, without limitation, values, redemption merchants, offer descriptions, offer limitations, coupon IDs, scannable symbols representative of the offers and/or coupon IDs (e.g., barcodes, QR codes, etc.), expiration times/dates, etc. And, like the consumer data structure and the transit data structure above, the offer data structure may be located as part of the data structure 122 (as described), or it may be located apart from the data structure 122 and the engine 120, for example, at the merchants 102a-b and/or the transit authority 110, or elsewhere, etc.

Various ones of the offers in the offer data structure may be based on a number of factors including, for example, transit conditions, etc., where the offers include a first value in the absence of a particular transit condition and a second value in the presence of the particular transit condition, and potentially a still different third value dependent on the presence of a further transit condition and/or a type of transit involved, etc. In addition, various ones of the offers in the offer data structure may be valid for only a limited duration (or interval or term), which may or may not be consistent with a duration (or expected duration) of a corresponding transit condition. As an example, when a transit condition includes a 30-minute delay of a flight, the offer included in the offer data structure may include an offer from merchant 102a located at the airport (as provided to the offer data structure by the merchant 102a) for $5 off any purchase of $20 or more, and may further be available for the period of the delay of the consumer's flight.

Further, various ones of the offers in the offer data structure may include enhanced offers, where the existing offers in the offer data structure are further supplemented/enhanced by one (or both) of the transmit merchant 102b and the transit authority 110 associated with a particular transit event affected by a transit condition. For instance, the offer in the above example from the merchant 102a for $5 off any purchase of $20 or more may be enhanced by the travel merchant 102b (and/or the travel authority 110) to $10 off any purchase of $20 or more if redeemed during the delay period of the consumer's flight (or if redeemed from a present time up until the consumer departs on his/her flight).

With that said, generally in operation in the system 100, when a transit condition occurs (e.g., a transit event is delayed, etc.), the offer engine 120 is configured to initially identify the transit condition, often based on reporting of the transit condition from the transit merchant 102b and/or the transit authority 110 (however, such reporting could be by the consumer 114 as well). In response, the offer engine 120 is configured to access the data structure 122 (or the constituent data structure wherever located), to select an offer from the offer data structure based on the transit type and the transit condition (and potentially based on a profile of the consumer 114 as affected by the identified transit condition (e.g., match the transit condition to one or more transit events associated with the consumer 114, etc.), and to issue the offer to the consumer 114 at the communication device 116 (e.g., via the application 118, via an SMS message, etc.). The consumer 114 is then permitted to redeem the offer at a merchant associated therewith (e.g., the merchant 102a, etc.), for example, within a date/time indicated in the offer (e.g., in a purchase transaction consistent with the one described above, etc.).

In connection with selecting and issuing the offer to the consumer 114, the offer engine 120 may be configured to perform various additional operations in the system 100. For example, the offer engine 120 may be configured to determine an alternate transit event for the consumer 114 (such that the consumer 114 may be able to use the alternate transit event to avoid the identified transit condition); select the offer based on the alternate travel event; select the offer based on a time, date, location, current transit event, etc.; notify the consumer 114 of the transit condition; receive an input from the consumer 114 indicative of the transit condition; etc. These will be described in more detail hereinafter.

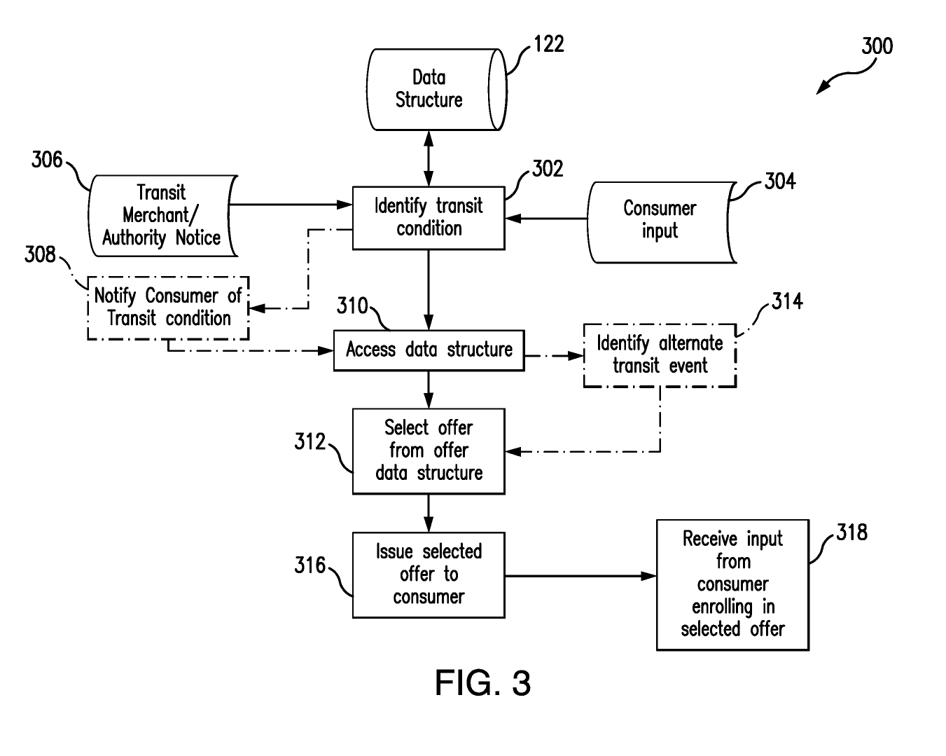

FIG. 3 illustrates an exemplary method 300 for providing an offer to a consumer based on a transit condition associated with travel by the consumer. The exemplary method 300 is described as implemented in the offer engine 120 of the system 100 (in association with the application 118 at the consumer's communication device 116), with additional reference to the computing device 200. However, it should be understood that the method 300 is not limited to the system 100 or the computing device 200, as it may be implemented in other systems and/or in other computing devices. Likewise, the systems and the computing devices herein should not be understood to be limited to the exemplary method 300.

Initially in method 300, the offer engine 120 identifies, at 302, a transit condition in connection with a transit event for the consumer 114. As described above in the system 100, in so doing, the offer engine 120 may identify the transit condition based on a variety of different inputs (e.g., inputs from the consumer 114, from the transit merchant 102b, from the transit authority 110, etc.).

In one example, the offer engine 120 identifies the transit condition based on a consumer input, at 304. In particular, the consumer 114 may inform the offer engine 120 of the transit condition through the communication device 116 (e.g., via the application 118, etc.). For instance, the consumer 114 may arrive for a train ride from location #1 to location #2 (i.e., a transit event) and learn that the train is delayed 40 minutes (i.e., a transit condition). In response, the consumer 114 may open the application 118, at the communication device 116, and select his/her train ride and indicate that it is delayed. In turn, a message is generated by the communication device 116 (in association with the application 118) and communicated to the offer engine 120, which then, in turn, identifies the transit condition. It should be appreciated that the consumer input to the application 118 may include other scenarios in which a transit event involves a transit condition, for example, the consumer 114 may input to the application 118 that location #1 is exceptionally busy (e.g., location #1 is experiencing a longer than normal security line to reach the boarding location for the train ride, etc.), that the train from location #1 to location #2 is overcrowded or overbooked, etc. In various embodiments, such inputs may include selection of predefined inputs from the application 118, or they may include text-based entries from the consumer 114, etc.

In another example, the transit merchant 102b and/or the transit authority 110 provides a notice, at 306, to the offer engine 120, indicating the transit condition. For instance, a flight from location #1 to location #2 provided by the transit merchant 102a may be delayed one hour due to mechanical issues with the corresponding plane. In response, the transit merchant 102b may then update the transit data structure (of the data structure 122) to indicate the one hour delay. In so doing, the transit merchant 102b may also provide notice to the offer engine 120 of the delay (either directly, or by way of updating the transit data structure whereby the offer engine 120 may then retrieve the notice of the transit condition from the transit data structure). As with the consumer inputs above, it should be appreciated that the notices from the transmit merchant 102b (and/or the transit authority 110) may include other scenarios in which a transit event involves a transit condition, for example, the transit authority 110 may provide a notice to the offer engine 120 that location #1 is exceptionally busy (e.g., location #1 is experiencing a longer than normal security line to reach the boarding location for the flight, etc.), or the transit merchant 102b may provide a notice to the offer engine 120 that the flight from location #1 to location #2 is overcrowded or overbooked, etc.

In either case, as part of identifying the transit condition, the offer engine 120 may identify transit events from the transit data structure (of the data structure 122) potentially affected by the transit condition and then also match one or more of the identified transit events for the transit condition to a particular transit event associated with the consumer 114 (or, the offer engine 120 may simply match the transit condition to a particular transit event associated with the consumer 114). Regardless, this may include, for example, receiving a particular indication of the transit event from the consumer 114, via the communication device 116 (when the consumer identifies the corresponding transit condition at 304 through the application 118). Or, this may include accessing the data structure 122 and retrieving a consumer profile for the consumer 114 (from the consumer data structure), and identifying the transit event therefrom (when the offer engine 120 receives the notice indicating the transit condition at 306).

In particular, for example, in the latter, the offer engine 120 may retrieve/access transaction data for the consumer 114, from the consumer's profile (or otherwise), at the data structure 122, and plot a transit path for the consumer 114 based thereon (e.g., for a given day, for a given week, for another interval, etc.). In addition (or alternatively), the offer engine 120 may retrieve/access calendar data for the consumer 114, from the consumer's communication device 116 (e.g., via the application 118, etc.), to supplement the transit path with known/planned transit events for the consumer 114. In so doing, the transit path, when plotted (e.g., potentially similar to what is shown in Table 1, etc.), may include common transit events for the consumer 114 (e.g., transit to work in the morning on weekdays, from work in the evenings on weekdays, to particular locations on regular bases (e.g., regularly attended meetings, classes, etc.), etc.), and/or specific/less common transit events (e.g., transit to vacation destinations, etc.). Further, the transit path may also include an indication of the associated transit types used along the common transit path (for each of the identified transit events). With that said, it should be appreciated that the transit path may be constructed based on location data provided from the communication device 116, automatically, or as directed by the consumer 114. In this manner, the offer engine 120 is able to then search, in the consumer's transit path, for particular transit events potentially affected by the given transit condition, and thereby match the transit condition to a particular transit event for the consumer 114. What's more, the offer engine 120 may then also use the transit path, subsequently, as a basis for selecting and providing one or more offers to the consumer 114, when a transit event associated with the consumer is affected by a transit condition (e.g., the offer engine 120 may select an offer (be it a non-transit product offer or a transit product offer) based on a subsequent travel event for the consumer 114 in the transit path, the offer engine 120 may select a transit product offer that not only accommodates the consumer's transit event directly affected by the transit condition but that also accommodates subsequent transit events in the consumer's transit path (to help mitigate overall travel disruption), etc.)

In addition in the method 300, the offer engine 120 may optionally, as indicated by the dotted lines in FIG. 3, notify the consumer 114 (at his/her communication device 116) of the transit condition, at 308, as being matched to a transit event for the consumer 114, if appropriate. For example, if the consumer 114 initially provides the input indicative of the transit condition (at 304), the offer engine 120 may omit notifying the consumer 114, at 308, since the consumer 114 is already aware of the transit condition. Conversely, if the transit condition is provided to the offer engine 120 from the transit merchant 102b and/or the transit authority 110 (at 306), the offer engine 120 may notify the consumer 114 of the transit condition, at 308, since the consumer 114 may not already be aware of the condition. In so doing, the offer engine 120 may transmit the notification to the consumer 114 at his/her communication device 116 via an SMS message, via the application 118, or otherwise.

With continued reference to FIG. 3, after identifying the transit condition (at 302) and the associated transit event for the consumer 114 affected by the transit condition, and after notifying the consumer 114 of the transit condition as appropriate (at 308), the offer engine 120 again accesses the data structure 122, at 310. In particular, here, the offer engine 120 accesses the consumer profile in the consumer data structure (if it has not done so already at operation 306, for example), and further accesses the offer data structure and the multiple offers included therein. Then, the offer engine 120 selects an offer (or multiple offers) from the offer data structure, at 312, for the consumer 114. The particular offer(s) may be selected, by the offer engine 120, based on, for example, the identified transit condition, the transit history of the consumer 114, the transaction data of the consumer 114 (transit transaction data and/or other transaction data), the current location of the consumer 114 (and, in particular, the location of the consumer's communication device 116), and the current time and/or date, etc.

As an example, the offer engine 120 may rely on the transit history of the consumer 114 to select offers related to the transit condition, based on the transit history. For instance, the consumer 114 may routinely travel to work in the morning by train. Consistent with this transit data, the offer engine 120 may select an offer from the offer data structure provided by a coffee shop merchant (e.g., consistent with merchant 102a, etc.) located at the train station where the consumer 114 boards the train in the morning for his/her travel to work (e.g., when the train is affected by a transit condition, etc.). Or, the offer engine 120 may select an offer from the train merchant (e.g., consistent with the transit merchant 102b, etc.) for a free train ride for the typical route take by the consumer 114 to/from work.

As another example, the offer engine 120 may (additionally or alternatively) rely on transaction data of the consumer 114 (e.g., of one or more payment accounts associated with the consumer 114, etc.) to indicate particular interests of the consumer 114 (e.g., based on frequent purchases, etc.) as part of identifying an offer (or multiple offers) for the consumer 114. For instance, the consumer 114 may have more than ten transactions involving Italian restaurants in the last three weeks. Consistent with this transaction data, the offer engine 120 may select an offer provided by an Italian restaurant (e.g., consistent with merchant 102a, etc.) (e.g., when a transit event for the consumer 114 is affected by a transit condition, etc.). Alternatively, the consumer 114 may have multiple transactions for plane tickets to a particular destination. Consistent with this transaction data, the offer engine 120 may select an offer provided by an airline provider (e.g., consistent with transit merchant 102b, etc.) for a flight to the particular destination, when a transit event for the consumer is affected by a transit condition.

As still another example, the offer engine 120 may (additionally or alternatively) rely on the current (or latest) location of the consumer 114 (as determined from the consumer's communication device 116), or potentially, the location associated with the transit event for the consumer 114 related to the transit condition in selecting an offer (or multiple offers) for the consumer 114 (e.g., when a transit event for the consumer 114 is affected by a transit condition, etc.). For instance, in connection with the above example in which the offer engine 120 selects an offer provided by an Italian restaurant, the offer engine 120 may more particularly select an offer provided by an Italian restaurant located in the current vicinity of the consumer 114 and/or in the vicinity of the location associated with the transit event affected by the transit condition (e.g., an Italian restaurant across the street from a train station associated with the consumer's transit event, etc.).

In another example, the offer engine 120 may (additionally or alternatively) rely on the current time/day in connection with selecting an offer (or multiple offers) for the consumer 114 (e.g., when a transit event for the consumer 114 is affected by a transit condition, etc.). For instance, in connection with the above example in which the offer engine 120 selects an offer provided by an Italian restaurant, the offer engine 120 may more particularly select an offer provided by an Italian restaurant located in the current vicinity of the consumer 114 and/or in the vicinity of the location associated with the transit event affected by the transit condition and limit the offer for use on the current day and for the next hour.

Optionally in the method 300, as indicated by the dotted lines in FIG. 3, upon identifying the transit condition and the associated transit event for the consumer 114, the offer engine 120 may identify an alternate transit event (or multiple alternate transit events) for the consumer 114, at 314. Such alternate transit event(s), if used by the consumer 114, may allow the consumer 114 to avoid (or mitigate) the transit condition encountered during his/her travel and still arrive at his/her destination on time, or at least with a shorter delay than with his/her prior transit event. Further, in connection with the alternative transit event(s), the offer engine 120 may select an offer, or multiple offers related to the alternate transit event(s), in the same way as described above (potentially in lieu of the offers for the prior transit event, or in addition thereto). In this manner, the offers (or additional offers) associated with the alternative transit event(s), as provided to the consumer 114, may provide further incentive to the consumer 114 (or may further encourage the consumer 114) to utilize one of the alternative travel events suggested by the offer engine 120 (instead of waiting for his/he prior transit event).

As can be appreciated, the above illustrates how offers provided to the offer engine 120, from the merchants 102a-b (or from other merchants), may be selected by the offer engine 120 for potential use by the consumer 114. In addition, supplemental offers may also be included in the offer data structure, which are provided from the transit merchant 102b and/or the transit authority 110, in response to the transit condition. For example, if a train ride, offered by the transit merchant 102b, and managed by the transit authority 110, is expected to be overcrowded (e.g., exceeds a predetermined threshold, etc.), based on the number of passes sold, the supplemental offers may be used, by the transit merchant 102b and/or the transit authority 110, to shift the consumer 114 (and potentially other consumers with tickets/passes for the particular train ride) from the train ride to an alternate train ride (in order to reduce congestion on the train ride, etc.). In connection therewith, where the merchant 102a is the Italian restaurant from the examples above, who has now provided a 10% off coupon to the offer data structure, the supplemental offer may enhance the discount to 20% off, with the added discount being paid by (or funded by) the transit merchant 102b and/or the transit authority 110. In this manner, the transit merchant 102b and/or the transit authority 110 are permitted to encourage the consumer 114 to have dinner at the Italian restaurant merchant 102a, and to take a later or different transit event to get home (or elsewhere).

Further, the offers selected by the offer engine 120 are typically provided for a limited interval (e.g., for a predefined term, etc.), including, for example, an interval associated with the transit condition. For example, where the transit condition includes a 30-minute delay of a flight, the offer from the merchant 102a, for example, may only be available for the period of the delay. In addition (or alternatively), when the offer is enhanced as described above, it may be enhanced by the transit authority 110 by $5 or 15% only during the interval of the delay, i.e., the 30 minutes, or the enhancement may further supplement the offer (e.g., extend the offer, etc.) from a present time up until the departure of the flight. It should be appreciated that the offer or supplements to the offers may, or may not, be limited by a variety of different time intervals, related to the transit condition, or the content of the particular offers selected, etc. It should further be appreciated that, in addition to the supplements offered by the transit authority 110, or in lieu thereof, merchants (e.g., the merchant 102a, the merchant 102b, etc.) may define different offers based on transit conditions (or otherwise), to attract consumers, including the consumer 114, during transit conditions.

Finally, with continued reference to FIG. 3, once the offer is selected, the offer engine 120 issues the offer to the consumer 114, at 316, at the consumer's communication device 116 (e.g., via an SMS message, via notification to the application 118, etc.). And, in turn, the consumer 114 can select/accept the offer, upon which the offer engine 120 receives an input from the consumer 114 (and, more particularly, from the consumer's communication device 116) enrolling in the selected offer. The offer can then be used by the consumer 114 in a transaction, for example, with the merchant 102a in the manner described above. Then, upon confirmation that the consumer 114 has satisfied the offer, the entity that provided the offer (and the transit merchant 102b and/or the travel authority 110 when supplementing the offer) is able to fund the offer (and the supplemental offer, as appropriate). In connection therewith, for example, the offer portion of the transaction is settled with the merchant 102a, typically at a regular interval (e.g., weekly, monthly, etc.), by calculating an amount/value of all offers (and supplemental offers) used (and attributed to the merchant 102a, to the merchant 102b, to the transit authority 110, etc.) and billing the calculated amount/value to the appropriate entity (to the merchant 102a, to the merchant 102b, to the transit authority 110, etc. that originally provided the offer). In turn, the billed amount is collected through a central system and ultimately paid to the merchant 102a, merchant 102b, etc. at which the offer was used. In the event a discount is taken at a register at the merchant 102a, for example, the merchant 102a would be paid from the central system.

In view of the above, the systems and methods herein evaluate transit conditions and transit events for consumers and, when the transit conditions affect the transit events, provide product offers to the consumers to help alleviate any inconveniences and/or other problems experienced by the consumers as a result of the transit conditions (in connection with their transit events). In this manner, the product offers are generally directed to (and/or tailored to) the consumers, so that they may particularly offset the impact of the transit conditions for the consumers, on individual bases, and soften any negative perception the consumers may have toward the transit merchants and/or transit authorities associated with the affected transit events. In addition, in various implementations of the systems and methods, the product offers may also be used by the transit merchants and/or the transit authorities to alter, for example, loading of the transit events when affected by the transit conditions. Thus, as provided herein, the systems and methods can help facilitate travel by consumers (via their transit events) while mitigating negative experiences for the consumers when encountering the inevitable (and often undesired) transit conditions.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) in response to a transit condition, accessing a consumer profile for a consumer associated with the transit condition; (b) accessing an offer data structure having multiple offers relating to discounted purchase transactions, each of the multiple offers associated with a merchant; (c) selecting at least one offer from the multiple offers in the offer data structure, based on the transit condition and the consumer profile; (d) issuing the selected at least one offer to the consumer, at a communication device associated with the consumer, thereby permitting the consumer to redeem the selected at least one offer at the merchant associated with the at least one offer; (e) identifying the transit condition to the consumer based on an input from one of a transit merchant and a transit authority associated with the transit event; and (f) notifying the consumer of the transit condition, at the communication device.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” or “included with” another element or layer, it may be directly on, engaged, connected or coupled to, or associated with the other element or layer, or intervening elements or layers may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in providing offers to consumers based on transit conditions, the method comprising:
in response to a transit condition, accessing, by a computing device, a consumer profile for a consumer associated with the transit condition;
accessing, by the computing device, an offer data structure having multiple offers relating to discounted purchase transactions, each of the multiple offers associated with a merchant;
selecting, by the computing device, at least one offer from the multiple offers in the offer data structure, based on the transit condition and the consumer profile; and
issuing, by the computing device, the selected at least one offer to the consumer, at a communication device associated with the consumer, thereby permitting the consumer to redeem the selected at least one offer at the merchant associated with the at least one offer.

2. The computer-implemented method of claim 1, wherein selecting the at least one offer is further based on temporal data and location data associated with the consumer; and
wherein the location data includes at least one of a latest location of the communication device associated with the consumer.

3. The computer-implemented method of claim 2, wherein the transit condition includes one of a delayed transit event and attendance of a transit event exceeding a predetermined threshold.

4. The computer-implemented method of claim 1, further comprising identifying, by the computing device, the transit condition to the consumer based on an input from one of a transit merchant and a transit authority associated with the transit event.

5. The computer-implemented method of claim 4, wherein the at least one offer includes an offer provided from the merchant associated with the selected at least one offer and a supplemental offer provided by the travel authority; and
further comprising enrolling the consumer in the at least one offer, whereby upon confirmation of satisfying the at least one offer, the travel authority is able to fund the supplemental offer.

6. The computer-implemented method of claim 1, further comprising notifying the consumer of the transit condition, at the communication device.

7. The computer-implemented method of claim 6, wherein the transit condition includes a travel disruption associated with a transit event indicated in transaction data associated with the consumer; and
wherein the selected at least one offer includes an offer for an alternate transit event.

8. A non-transitory computer readable storage media including executable instructions for providing offers to consumers that, when executed by a processor, cause the processor to:
in response to a transit condition, identify a consumer associated with a transit event involved in the transit condition;
access an offer data structure, the offer data structure including multiple offers;
select at least one offer from the multiple offers based on the transit condition and a location of the consumer; and
enroll the consumer in the selected at least one offer, whereby the consumer is able to redeem the at least one offer when a term associated with the at least one offer is satisfied.

9. The non-transitory computer readable storage media of claim 8, wherein the at least one offer includes a supplemental offer provided by a transit authority associated with the transit event.

10. The non-transitory computer readable storage media of claim 9, wherein the executable instructions, when executed by the processor, further cause the processor, in order to identify the consumer associated the with the transit event, to:
receive an indication of the transit condition and the transit event from at least one of the transit authority and a transit merchant associated with the transit event; and
search in the consumer profile for the transit event.

11. The non-transitory computer readable storage media of claim 8, wherein the executable instructions, when executed by the processor, further cause the processor, in order to identify the consumer associated the with the transit event, to:
identify a common transit path for the consumer, the common transit path including the transit event; and
identify the consumer based on the transit event being included in the common transit path.

12. The non-transitory computer readable storage media of claim 8, wherein the executable instructions, when executed by the processor, further cause the processor to notify the consumer regarding the transit condition and to issue the selected at least one offer to the consumer, prior to enrolling the consumer in the selected at least one offer.

13. The non-transitory computer readable storage media of claim 8, wherein the at least one offer includes an offer for an alternate transit event, for the transit event.

14. The non-transitory computer readable storage media of claim 13, wherein the term associated with the at least one offer includes an offer interval, during which the at least one offer is able to be redeemed.

15. The non-transitory computer readable storage media of claim 14, wherein the offer interval is based on an expected departure of the transit event.

16. The non-transitory computer readable storage media of claim 8, wherein the executable instructions, when executed by the processor, further cause the processor, in connection with selecting at least one offer from the multiple offers, to further select the at least one offer based on transaction data associated with a payment account of the consumer.

17. A system for use in providing offers to consumers based on transit conditions affecting transit events associated with the consumers, the system comprising:
a memory comprising a consumer data structure, a transit data structure and an offer data structure, the transit data structure including multiple transit events associated with at least one transit merchant and the offer data structure including multiple product offers associated with different product merchants;
an engine in communication with the memory and configured to:
generate a consumer profile for a consumer and store the consumer profile in the consumer data structure in the memory, the consumer profile including a travel entry for the consumer associated with a transit event;
identify a transit condition and retrieve, from the transit data structure in the memory, transit events associated with the identified transit condition;
match the transit event associated with the travel entry for the consumer in the consumer profile to at least one of the retrieved transit events associated with the identified transit condition;
retrieve an offer from the offer data structure in the memory based on the transit condition and the transit event associated with the travel entry for the consumer in the consumer profile; and
issue the retrieved offer to the consumer, at a communication device associated with the consumer, thereby permitting the consumer to redeem the offer at the merchant associated with the offer.

18. The system of claim 17, wherein the consumer profile for the consumer includes transaction data associated with a payment account for the consumer; and
wherein the engine is configured, in connection with retrieving an offer from the offer data structure, to further retrieve the offer based on the transaction data included in the consumer profile for the consumer.

19. The system of claim 18, wherein the engine is configured, in connection with generating the consumer profile for the consumer, to plot a transit path for the consumer based on the transaction data included in the consumer profile for the consumer, the transit path including the travel entry for the consumer.

20. The system of claim 17, wherein the engine is further configured to notify the consumer of the matching transit event associated with the travel entry for the consumer in the consumer profile, when the transit event matches at least one of the retrieved transit events associated with the identified transit condition.
